(19) United States
(12) Patent Application Publication
(10) Pub. No.: US 2005/0059293 A1
(43) Pub. Date: Mar. 17, 2005

(54) Modular cable-holding device

(75) Inventor: Hui-Tsang Chang, Hsinchu (TW)

Correspondence Address: BRUCE H. TROXELL;SUITE 1404, 5205 LEESBURG PIKE, FALLS CHURCH, VA, 22041, US

(73) Assignee: Accton Technology Corporation

(21) Appl. No.: 10/663,649

(22) Filed: Sep. 17, 2003

(51) Int. Cl. H01R 13/58

(52) U.S. Cl. 439/449

(57) ABSTRACT

The invention provides a modular cable-holding device for supporting for an electronic device connected with a cable. The modular cable-holding device comprises a top plane, two side walls, and at least one hooking element. The top plane is for connecting with the electronic device, while two side walls arranged at two sides of the top plane prop the top plane up an appropriate altitude and form an accommodating space. At least one side wall has an opening trough having a neck part for preventing the cable from dropping out. As passing through the opening trough and entering the accommodating space, the cable is fixed securely by the hooking element.

### 1. FIELD OF THE INVENTION

The invention relates to a cable-holding device for electronic appliances, and particular to a modular cable-holding device assembled with an electronic device, such that a cable-holding function is reached.

### 2. BACKGROUND OF THE INVENTION

Technology changes with each passing day. After industrial revolution, the invention of computer has brought deep and far influence on human world since the middle of the twentieth century. From vacuum tube computer, transistor computer to microcomputer having integrated circuit, people may use the fast computer to proceed giant amount of data management and complicated computation, which may be executed in multiple parallel processing manner and may be maintained under high precision and reliability. Soon after the invention of computer, the birth of Internet is doubtlessly called the “The Revolution of Third Wave”. People may have their computers interconnected to dense communication network with nodes' connection by early telephone line dial in, ISDN, and ADSL to late various mobile communication and mobile data internet access. From local area network (LAN) to Internet, people may communicate the whole world from anywhere of the Earth just by accessing to the web. Internet initialized most early from military usage has thoroughly changed the communication way between people and accelerated the information communication and share between each other. From electronic mail, network bookstore, online theater, web order, and electronic transaction and market, etc., they are all coming out because of Internet. The influence of Internet has globally penetrated into every corner of people's daily living so as to bring people into a so-called “acknowledge economics”.

But, under the limited land resource, people's action space is compressed and reduced, so electronic product and relative network product have gradually developed into upright structure in order to save usage space. Please refer to FIG. 1, which is the structural illustration for the interconnection between the web products and the connecting cable common seen in current market. Herein, only power line is used to demonstrate this cable, but it is not a limitation to this kind. The network product 1 sold in common market is powered with a cable 2. The network product 1 has a power socket 11 connected with a plug 21 of the cable 2. When the network product 1 is used, the cable 2 is sometimes pulled casually, such that the plug 21 loosens and drops out from the power socket 11 to interrupt the power of the network product 1, so the network product 1 sold in common market has following shortcomings:
1. Since the network product 1 can not prevent the cable 2 from being easily loosened off when being pulled casually, the power supply of the network product 1 may be interrupted unwillingly. To an operator, the product design is not of safety, nor of humanity.
2. If the connecting and holding design of the plug 21 is changed, the network product 1 must be modified correspondingly, such that the cost and the complexity of design will increase, and the selection will be limited to the same kind of cable as the cable 2.
3. If a holding element is added to the casing of the internet product 1 to fix the cable 2, it is not only that the holding element is easy to damage for weak structure, the outlook of the network product 1 is defective.

Therefore, how to solve the aforementioned shortcomings of the network product 1 and to lower down its manufacturing cost is indeed a goal urgently pursued by the manufacturers.

### SUMMARY OF THE INVENTION

The main objective of the invention is to provide a modular cable-holding device, which is adapted for various electronic devices and to provide such functions as holding lines and disposing the electronic device firmly.

The secondary objective of the invention is to provide a modular cable-holding device, which prevents the cable from being pulled to loosen off or prevents the electronic device from falling down, so the function for securely holding the cable may be reached.

Another objective of the invention is to provide a modular cable-holding device, which prevents extra elements from being deployed upon the electronic device for holding the cable so as to reduce the assembly cost, and the goal of molding production may be fulfilled.

Further another objective of the invention is to provide a modular cable-holding device, which may prevent additional elements from being designed upon the outer surface of an electronic device, such that the the elegance and integrity of the entire appearance of the electronic device may be fulfilled.

To reach the objectives, the modular cable-holding device according to the invention provides a support for an electronic device connected by a cable, and the modular cable-holding device comprises a top plane, two side walls, and at least one hooking element.

The top plane is for connecting with the electronic device.

Two side walls are deployed at two opposing sides of the top plane for propping the top plane up an appropriate altitude and forming an accommodating space, and an opening trough having a neck part is formed on at least one side wall, the cable can pass through the opening trough and constrained by the neck part.

The hooking element is deployed in the accommodating space for winding the cable.

As passing through the opening trough and entering the accommodating space, the cable can wind around the hooking element and be fixed well.

Following drawings are cooperated to describe the detailed structure and its connecting relationship according to the invention for facilitating your esteemed members of reviewing committee in understanding the characteristics and the objectives of the invention.

### BRIEF DESCRIPTION OF THE DRAWINGS

FIG. 1 is a structural illustration for an interconnection between a cable and the electronic product according to prior arts.

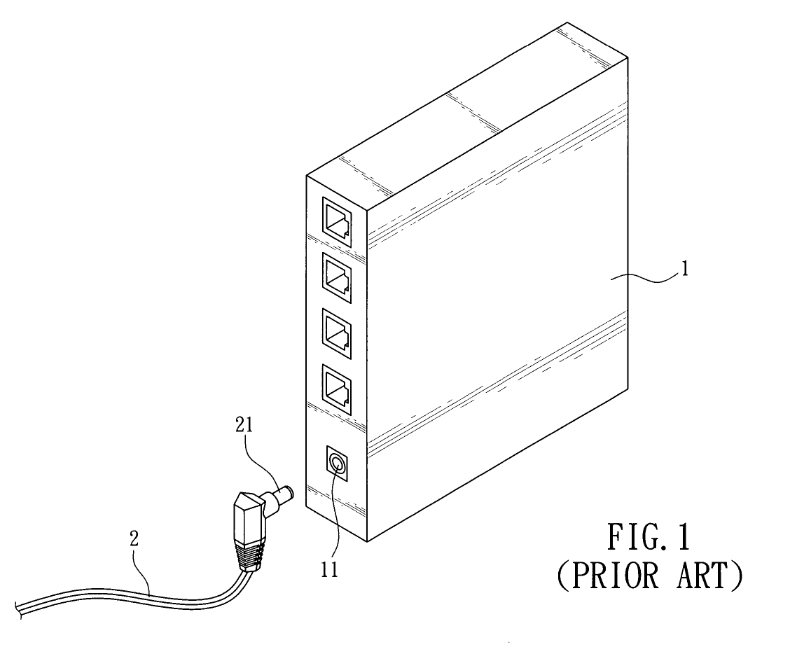

FIG. 2A is an illustration for the appearance structure of a preferable embodiment for an electronic device supported by the modular cable-holding device according to the present invention.

FIG. 2B is an illustration for the appearance structure of a preferable embodiment, wherein an electronic device is formed integrally with the modular cable-holding device according to the present invention.

FIG. 3 is a top perspective view for a preferable embodiment of the modular cable-holding device according to the present invention.

FIG. 4 is a bottom perspective view for a preferable embodiment of the modular cable-holding device according to the present invention.

FIG. 5 is a top perspective view for a preferable embodiment of a cable accommodated in the modular cable-holding device according to the present invention.

FIG. 6 is a bottom perspective view for a preferable embodiment of a cable accommodated in the modular cable-holding device according to the present invention.

### DETAILED DESCRIPTION OF THE INVENTION

The essential of the present invention is to provide a modular cable-holding device to support an electronic device and hold the cable of the electronic device. The cable-holding device provides a function for preventing the falling of the electronic device or loosening of the cable of the electronic device caused by pulling the cable casually.

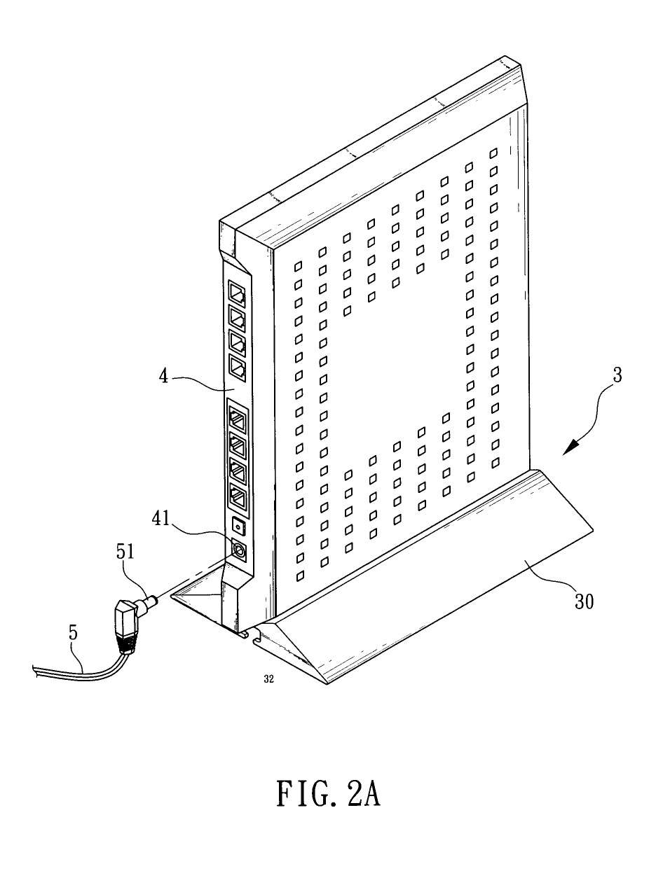

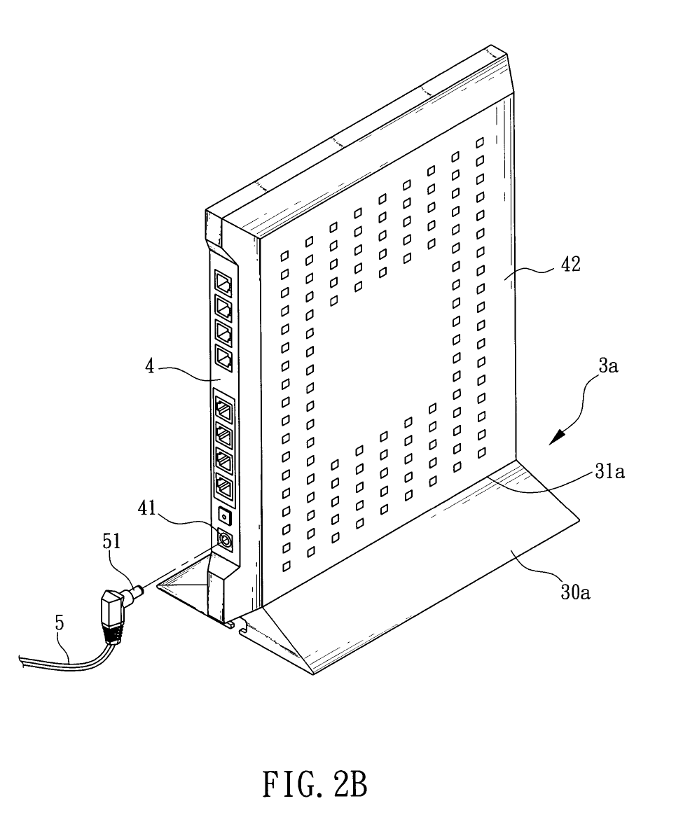

Please refer to FIG. 2A, which is an illustration for the appearance structure of a preferable embodiment, wherein an electronic device is supported by the modular cable-holding device according to the present invention. In this preferable embodiment according to the invention, the modular cable-holding device 3 comprises a main body 30, which is manufactured by the plastic injection molding, and provides a support for an electronic device 4 having a power socket 41 connected electrically with a plug 51 of a cable 5, such that the power is supplied to the electronic device 4 via the cable 5. Herein, a power line, as the example of the cable 5, is not a restriction for the type of cable, same as those hereinafter.

Additionally, please refer to FIG. 2B, which is the appearance structural illustration of a preferable embodiment, wherein an electronic device is integrated with the modular cable-holding device according to the present invention. In this preferable embodiment of the invention, the main body 30a and the casing 42 of the electronic device 4 are formed as a whole. Herein, the top plane 31a of the main body 31 may become one part of the casing 42. For describing the following preferable embodiments in a convenient way, it needs to be pointed out in advance that the modular cable-holding device 3 of the invention is shown as one single structure being separated from the casing 42.

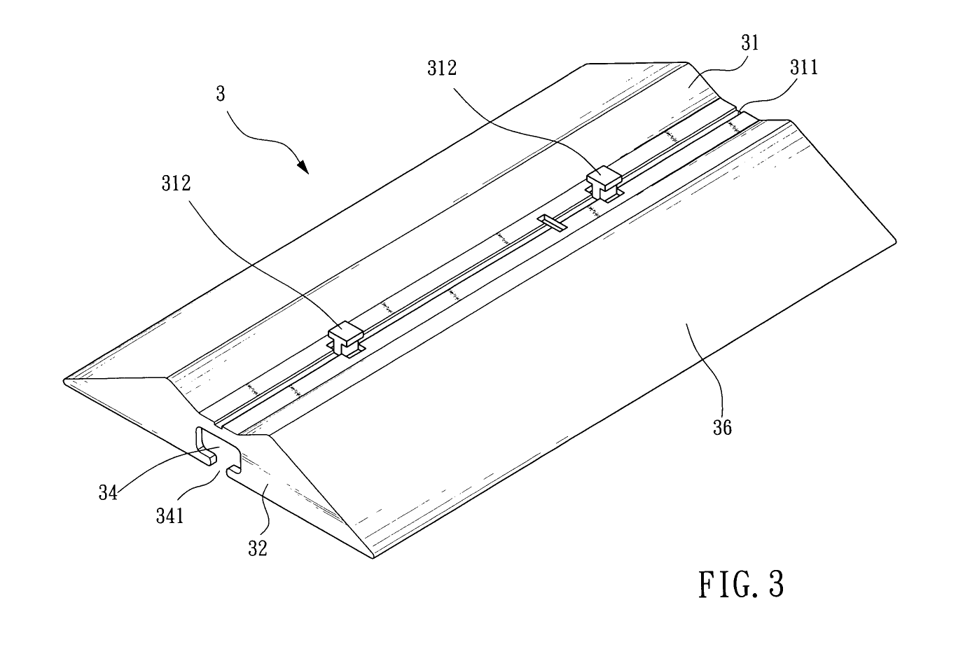

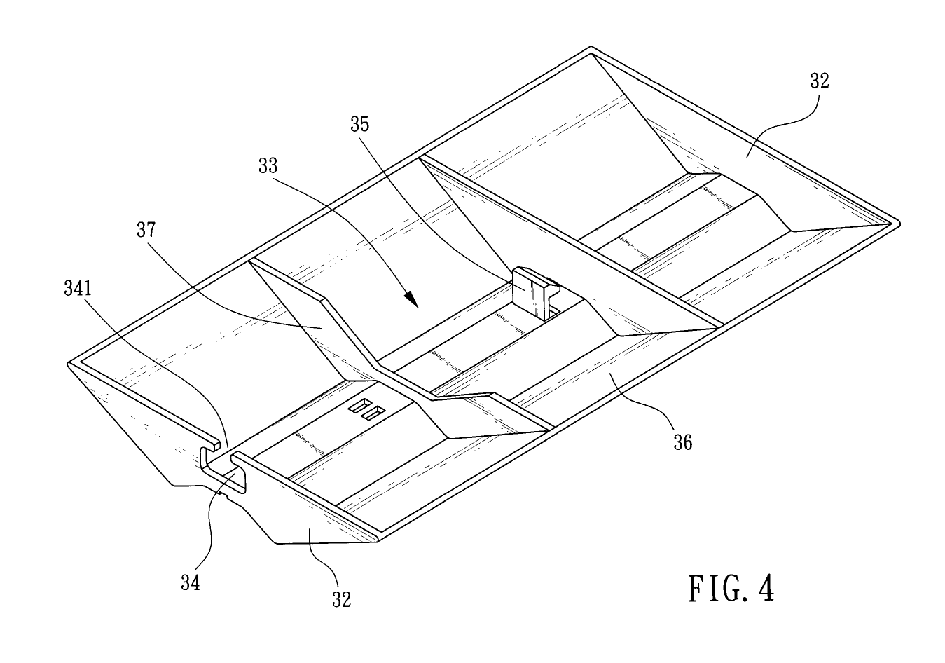

Please refer to FIG. 3 and FIG. 4, which are top and bottom perspective views of the modular cable-holding device according to the present invention. In this preferable embodiment, the modular cable-holding device 3 comprises a top plane 31, two side walls 32, and at least one hooking element 35. The top plane 31 optionally formed with a recess 311 and at least one guiding hook 312 is for connecting with the electronic device. The electronic device 4 slides along the recess 311 and is gripped by the guiding hook 312. However, the number of guiding hook 312 is not limited to two, as shown in FIG. 3. In another embodiment, the invention can be shown as FIG. 2B, in which the main body 30a and the casing 42 are formed as a whole without the recess 311 and the guiding hook 312 upon the top plane 31a. Moreover, two side walls 32 are respectively deployed at two opposing sides of the top plane. Two side walls 31 may prop the top plane 31 up an appropriate altitude. And two inclining side planes 36 are formed with the top plane 31 and two side walls 32, therefore, an accommodating space 33 constructed by the top plane 31, two side walls and two inclining planes 36 may deploy the hooking element 35 internally.

In this preferable embodiment of the present invention, the accommodating space 33 is further deployed at least one separating element 37 that is spaced apart appropriately inside the accommodating space 33. The separating element 37 is for reinforcing the structure of the main body 30. The hooking element 35 may be directly deposed on the top plane 31 or on the separating element 37. At least one side wall 32 further has an opening trough 34 having a neck part 341. In this preferable embodiment of the invention, the opening trough 34 is formed on one side wall 32. Otherwise, it is possible to form an opening trough 34 on each of two side walls 32. The number of the separating element 37 may vary with different strength requirement of the structure.

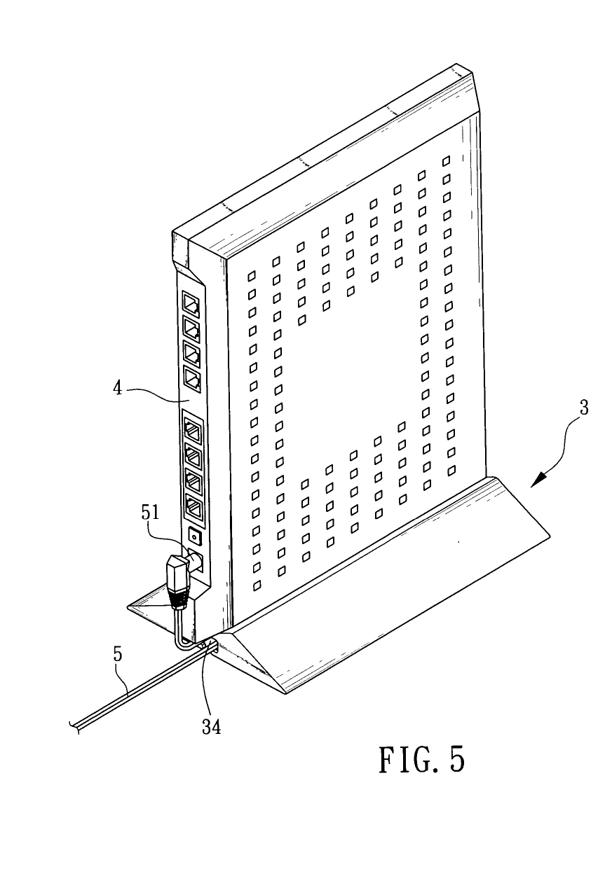

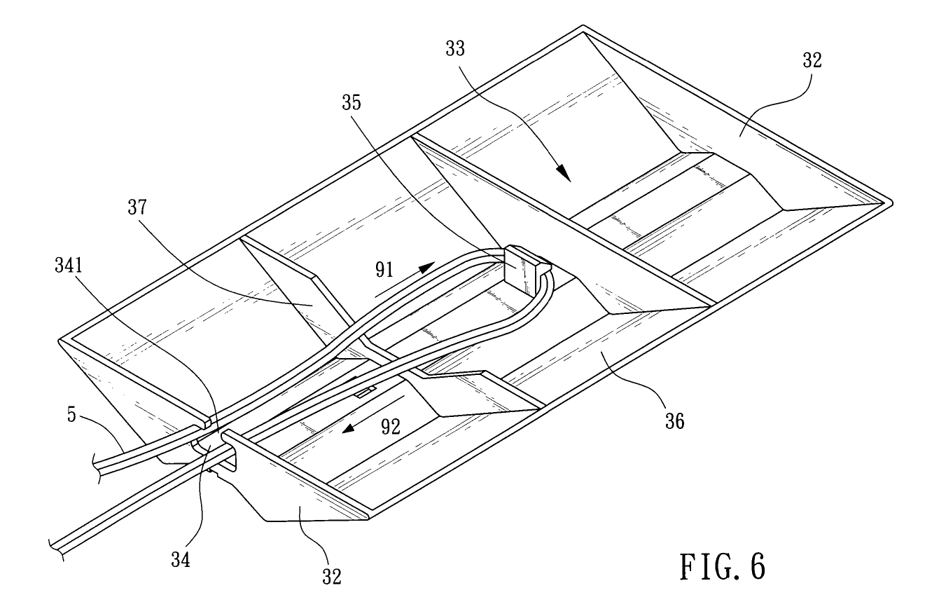

Please refer to FIG. 5 and FIG. 6, which are top and bottom perspective views for a preferable embodiment of a cable accommodated in the modular cable-holding device according to the present invention. In this preferable embodiment, the cable 5 passes through the neck part 341 and enters the opening trough 34. Afterward the cable 5 passes through the opening trough 34 in a first direction 91 for entering the accommodating space 33 and wind the hooking element 35. Then, the cable 5 exits the accommodating space 33 in a second direction 92 by passing through the neck part 341 and opening trough 34. The first direction and the second direction preferably point two opposite directions. Accordingly, with the shrink of the neck part 341, the cable 5 is not easy to drop out from the accommodating space 33. Furthermore, when the cable 5 is pulled by accident, the direct pulling force applying upon the plug 51 may be reduced by the friction between the hooking element 35 and the cable 5, such that it prevents the plug 51 from loosening off or separating from the power socket 41.

In summary, the modular cable-holding device according to the present invention includes the following advantages:
1. It may support any kind of electronic device and firmly dispose this electronic device.
2. It may safely hold the cable to prevent the electronic device from falling down to interrupt its function when the cable is pulled by accident.
3. It is unnecessary to add any extra element on the electronic device for holding the cable, such that it prompts the assembly of the electronic device, and reduce the cost of manufacture.
4. Since no extra element will be added upon the contour of the electronic device, the outer appearance of the electronic device will be clean and neat.

The aforementioned modular cable-holding device according to the present invention may indeed overcome the shortcomings of the prior arts to satisfy the requirement of industry and increase the competition capability.

However, the aforementioned description is just several preferable embodiments according to the present invention, and of course, can not limit the range of the invention, so any equivalent variation and modification made according to the claims claimed by the invention are all still in the scope covered by the patent of the present invention. Please your esteemed members of reviewing committee examine the present application in clear way and grant it as a formal patent as favorably as possible.

1. A modular cable-holding device for supporting an electronic device connected with a cable, comprising:
a top plane connected with the electronic device;
two side walls deployed at two opposing sides of the top plane for propping the top plane up an appropriate altitude and forming an accommodating space for receiving the cable, wherein at least one side wall has an opening trough with a neck part; and
a hooking element deployed in the accommodating space for holding the cable.

2. The modular cable-holding device according to claim 1, wherein the top plane comprises:
a recess for supporting the electronic device.

3. The modular cable-holding device according to claim 1, wherein the top plane comprises:
at least one guiding hook for joining the modular cable-holding device and the electronic device.

4. The modular cable-holding device according to claim 1, wherein the modular cable-holding device is manufactured by plastic injection molding.

5. The modular cable-holding device according to claim 1, wherein the accommodating space comprises:
at least one separating element spaced apart appropriately inside the accommodating space to reinforce the structure of the modular cable-holding device.

6. The modular cable-holding device according to claim 1, wherein the cable passes through the opening trough and enters the accommodating space in a first direction, and exits the accommodating space in a second direction through the opening trough after the cable wind around the hooking element.

7. The modular cable-holding device according to claim 6, wherein the first direction and the second direction are towards two opposite directions.
